(19) United States
(12) Patent Application Publication
(10) Pub. No.: US 2007/0008280 A1
(43) Pub. Date: Jan. 11, 2007

(54) Remote control for an audio signal playback system

(76) Inventor: Paul Ullmann, Vienna (AT)

Correspondence Address: PHILIPS INTELLECTUAL PROPERTY & STANDARDS, P.O. BOX 3001, BRIARCLIFF MANOR, NY, 10510, US

(21) Appl. No.: 10/569,718

(22) PCT Filed: Aug. 24, 2004
(86) PCT No.: PCT/IB04/51548

§ 371 Date: Feb. 24, 2006

(30) Foreign Application Priority Data
Aug. 28, 2003 (EP) 03103438.6

(51) Int. Cl. G09G 5/00

(52) U.S. Cl. 345/156

(57) ABSTRACT

In an audio-signal playback system, a remote control device (3) for remotely controlling a playback device (2) for audio signals comprises a detector (7) for detecting mobile-phone radio signals (5) from a mobile phone (4), wherein, on detection of the mobile-phone radio signal (5), the remote a control device (3) is designed to emit to the playback device (2), in a wireless manner, a volume-influencing signal (6) to influence the volume of the playback of the audio signals by the playback device (2).

The invention relates to a remote control device for remotely controlling a playback device, which playback device is designed for the acoustic playback of audio signals, and which playback device is designed to receive, in a wireless manner, volume-influencing signals emitted by the remote control device, and to control the volume of the playback of the audio signals in accordance with the received volume-influencing signals.

The invention further relates to an audio-signal playback system with a remote control device and with a playback device, which playback device is designed for the acoustic playback of audio signals, and which playback device is designed to receive, in a wireless manner, volume-influencing signals emitted by the remote control device, and to control the volume of the playback of the audio signals in accordance with the received volume-influencing signals.

The invention further relates to a method of influencing the volume of the playback of audio signals, which audio signals are emitted with the aid of a playback device, comprising the wireless transmission of a volume-influencing signal from a remote control device to the playback device, with which volume-influencing signal the volume of the playback of the audio signals by the playback device is influenced.

Owing to fact that high-quality audio/video systems are becoming ever more reasonably priced, consumers are understandably feeling the need to exploit the capabilities of these audio/video systems and to operate these systems at a high volume in order to obtain a realistic sound of music or films. On the other hand, with the rapid spread of mobile phones in recent years, the telephone behavior of consumers has changed to the extent that—thanks to the technical possibilities—they wish to be contactable by telephone at any time. It is apparent that, in the case of an audio/video system operated at high volume, the likelihood of a call being missed significantly increases. This prevents many consumers from concentrating on the audio playback. Instead, they are constantly listening “with one ear open” for the ringing of their mobile phone. The risk of missing a call is further increased if the user of an audio/video system is wearing headphones in order not to annoy the neighborhood with too high a volume.

For the reasons described, it would be desirable to have a device that assists the consumer in preventing him from missing any calls despite the high playback volume of audio/video systems or the wearing of headphones.

A playback device for generating and playing back an audio signal is known from document US 2003/0045265 A1. A detector detects a communications signal from a mobile phone or in-car telephone, and generates a muting signal, which is sent via an electrical connection to a muting circuit. The muting circuit is connected to an audio-signal playback circuit and suppresses the audio signal playback when it receives the muting signal.

The disadvantage has thereby arisen that the detector is designed to be either directly integral to the playback apparatus or as an automatic muting apparatus that has to be electrically connected to an existing muting socket of the playback apparatus, wherein an electrical lead is routed from the muting apparatus to the muting socket in order to mute the audio playback circuit. As a result of installation of the detector in the playback apparatus, the detector is usually located in an unfavorable detection position, so the signals emitted by a mobile phone are often too weak to be detected by the detector because the distance between the detector and mobile phone is too great. Although this problem rarely occurs in the case of in-car audio systems, for which the subject-matter of U.S. 2003/0045265 A1 was designed, owing to the restricted size of the passenger compartment, it is a serious problem in domestic appliances as regards the reliability of the signal detection. A further problem is the unwanted detection of signals from third-party mobile phones. Again, this problem is negligible in the case of in-car audio systems, as described in U.S. 2003/0045265 A1, since the vehicle body acts as a Faraday cage, which attenuates the signals from mobile phones outside the passenger compartment, whereas the detection of all mobile phones located inside the passenger compartment is always desirable. In the domestic sphere, however, the problem described is serious since the parasitic interference of signals from mobile phones from neighboring dwellings has to be anticipated. However, the consumer will have confidence in a detection appliance for telephone calls only if it operates reliably even under difficult environmental conditions. A stopgap solution, comprising positioning the mobile phone to be detected close to the audio playback device, will fail in practice because the radio signals from the mobile phone, which exhibit a relatively high field strength, interfere strongly with the audio signal as it plays back and, in unfavorable cases, could also cause other operational malfunctions in the audio playback device.

It is an object of the invention to rectify the above-mentioned problems and to create an improved remote control device and an improved audio-signal playback system and an improved method of influencing the playback volume of audio signals.

In order to achieve the above-mentioned object, features in accordance with the invention are provided in a remote control device in accordance with the invention, so a remote control device in accordance with the invention may be characterized in the following manner:

Remote control device for remotely controlling a playback device, which playback device is designed for the acoustic playback of audio signals, and which playback device is designed to receive, in a wireless manner, volume-influencing signals emitted by the remote control device, and to control the volume of the playback of the audio signals in accordance with the received volume-influencing signals, wherein the remote control device comprises a detector for detecting mobile-phone radio signals that can be generated with a mobile phone, and wherein, on detecting the mobile-phone radio signals, the remote control device is designed to emit to the playback device, in a wireless manner, a volume-influencing signal with which the volume of the playback of the audio signals by the playback device can be influenced.

In order to achieve the above-mentioned object, a remote control device in accordance with the invention is provided in an audio-signal playback system in accordance with the invention.

In order to achieve the above-mentioned object, features in accordance with the invention are provided in a method in accordance with the invention, so a method of influencing the volume of the playback of audio signals from a playback device may be characterized in the following manner:

Method of influencing the volume of the playback of audio signals, which audio signals are emitted from a playback device, comprising the detection of mobile-phone radio signals that can be generated with a mobile phone in a remote control device, and comprising the wireless transmission of a volume-influencing signal from the remote control device to the playback device, with which volume-influencing signal the volume of the playback of the audio signals by the playback device is influenced.

It is achieved by means of the features in accordance with the invention that the mobile phone(s) to be detected and the remote control device with integral detector can be positioned at a suitable distance from each other both for the radio signals from the mobile phone to be reliably detected and for interference to the playback device arising from parasitic interference from mobile-phone radio signals in audio-signal amplification circuits of the playback device to be prevented, since the mobile phone may be placed at a sufficiently great distance from the playback device. Since the remote control device operates wirelessly, it may also be positioned in almost any desired location in a room in which the playback device is located. Even if there is no direct visual connection between the remote control device and the playback device, satisfactory operation is ensured through the diffuse reflection on the walls or ceiling of the room.

It may be mentioned that the terms “audio-signal playback system” and “playback device for audio signals” should be taken to include audio/video systems, such as televisions or home cinema systems. However, since the present invention relates only to the sound component of television broadcasts and films, and not to the picture component, it would seem appropriate to clarify this by means of the terms used in the present description: “audio-signal playback system” and “playback device for audio signals”.

In accordance with the measures as claimed in claims 2 and 13, the advantage is obtained that the volume of the audio-signal playback is reduced before the mobile phone's acoustic ringing signal sounds, since the corresponding mobile-phone radio signals are transmitted a few seconds before the acoustic ringing signal. This is not possible with the audio-signal playback system disclosed in document U.S. 2003/0045264 A1, since, in this known system, the detected communications signals from the mobile phone are the call signals in the case of an already established connection or an ongoing phone call, whereas, in the present case, the identifier transmitted from the mobile phone to the base station before the call is established is filtered out. In fact, the known system is exclusively aimed at automatically muting the audio-signal playback of the audio system during a phone call, in order that the party receiving the call does not have to depress additional control keys on the audio system. The known system is mainly aimed at car drivers, the intention being to divert them less from the traffic conditions.

In accordance with the measures as claimed in claims 3 and 14, the advantage is obtained that a distinction can be made selectively between a telephone “call” and a data transmission over the mobile phone, wherein, in the latter case, it is generally unnecessary to reduce the volume of the audio-signal playback, since the data exchange between appliances (computers, fax machines etc.) will take place automatically without any intervention by the mobile phone user.

In accordance with the measures as claimed in claims 4 and 15, the advantage is obtained that the short signal pulses with which the mobile phone reports to the base station every couple of seconds are filtered out, and therefore no undesired reduction in the volume of the audio-signal playback takes place on the playback device.

In accordance with the measures as claimed in claims 5 and 16, the advantage is obtained that the listener is not startled by the abrupt muting of the audio-signal playback, wherein “gentler” measures can be taken, such as gradual volume reduction, or measures such as the stopping of a data carrier in order that, on completing the call, the listener can continue the audio playback at precisely the place at which it was interrupted. The functions claimed in the said claims are normally present in existing remote control devices, so it is possible to equip these remote control devices with the detector in accordance with the invention.

In accordance with the measures as claimed in claim 6, the advantage is obtained that the mobile phone is positioned at a defined, constant distance from the detector, which ensures optimum detection results. In addition, the consumer does not have to bother with setting up a separate mounting for the mobile phone.

In accordance with the measures as claimed in claim 7, the advantage is obtained that the mobile phone can be optimally charged in the quiescent state without the user having to connect it to a separate charger.

In accordance with the measures as claimed in claim 8, the advantage is obtained that the accidental detection of radio signals from third party mobile phones is prevented.

In accordance with the measures as claimed in claims 9 and 17, the advantage is obtained that the transmission of the volume-influencing signal takes place in a frequency range that is sufficiently far from the frequency range of the radio signals of the mobile phone that no mutual interference can occur.

It should be mentioned that the advantages mentioned above in connection with the remote control device in accordance with the invention also come into effect in relation to an audio-signal playback system in accordance with the invention.

The aspects discussed above and further aspects of the invention are apparent from the example of embodiment described hereinafter and are elucidated with reference to this example of embodiment.

The invention will be further described with reference to examples of embodiments shown in the drawings, to which, however, the invention is not restricted.

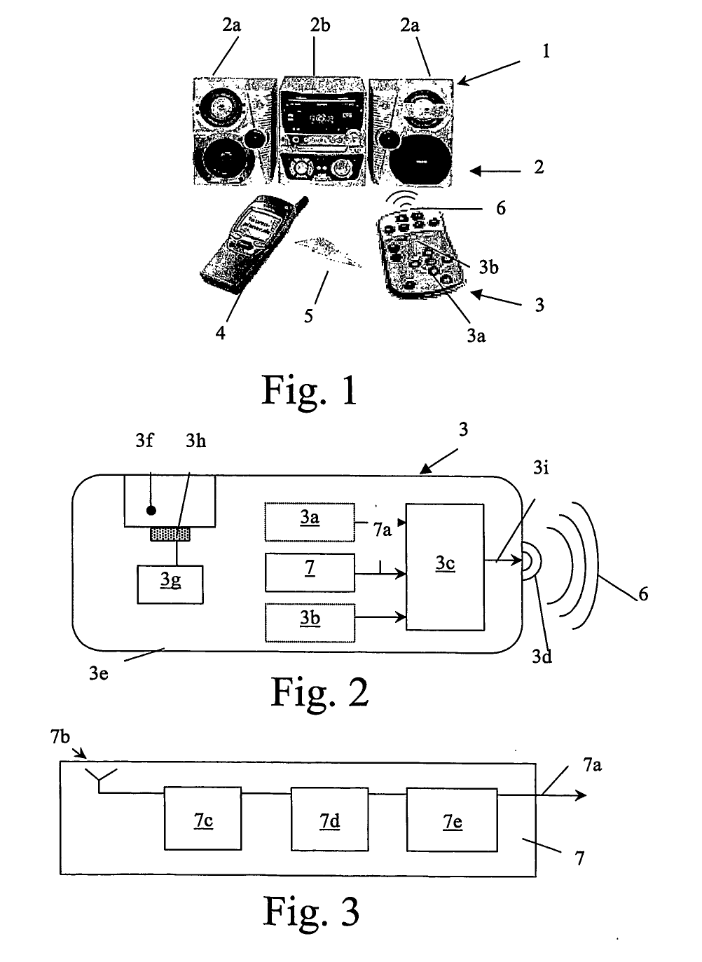

FIG. 1 shows a symbolic representation of an audio-signal playback system in accordance with the invention.

FIG. 2 shows, schematically, in the form of a block diagram, a remote control device in accordance with the invention.

FIG. 3 shows, in a manner analogous to FIG. 2, a detector in accordance with the invention for detecting mobile-phone radio signals.

FIG. 1 shows an audio-signal playback system 1 in accordance with the invention. This audio-signal playback system 1 comprises a playback device 2 for audio signals in the form of a stereo system, and a remote control device 3 for the wireless control of the functions of the playback device 2. The signals 6 transmitted from the control device 3 to the audio-signal playback device 2 lie in the infrared frequency range. It should be mentioned that the ultrasonic frequency range or the radio frequency range may also be provided.

The playback device 2 is equipped with a central unit 2b and loudspeaker boxes 2a connected to it, wherein a receiver for the signals 6 from the remote control device 3, multiple audio-signal sources, such as a CD player, an MP3 player etc., an audio-signal amplifier and circuits as well as control knobs to control the functions of the stereo system are provided in the central unit 2b in a known manner (not shown). These assemblies of the playback device 2 are part of the generally known prior art, and therefore require no further explanation. It should be mentioned that the playback device 2 may, for the purposes of the invention, equally well take the form of a television set or a home cinema system, i.e. may generally be an audio/video playback device.

The remote control device 3 shown in FIG. 2 comprises, in a known manner, a plurality of keys to control the functions of the playback device 2, including a keypad 3a to influence (increase, reduce, mute, fade) the volume. The audio-signal sources in the playback device 2 can be controlled with a further keypad 3b, wherein a stop function and a pause function serve to stop or pause the playback of audio signals from the appropriate audio-signal source. The actuation of the said keys causes key signals corresponding to the key depression to be transmitted to a remote controller 3c located inside the remote control device 3, as shown in the block diagram of FIG. 2. The remote controller 3c evaluates the key signals received from the keypads 3a, 3b and generates a control signal 3i, with which a signal transmission element 3d—an IR diode in the present case—is activated, and wirelessly transmits a signal 6 to the playback device 2, which is received and decoded there in order to execute the corresponding functions. Instead of the IR diode, an ultrasonic transducer may also be provided. If keys from the keypad 3a or a stop or pause key from the keypad 3b are actuated, the signal 6 emitted by the remote control device acts as a volume-influencing signal.

Integral to the remote control device 3 in accordance with the invention is a detector 7, which is designed to receive and evaluate mobile phone radio signals 5, which can be generated with a mobile phone 4. If the detector 7 establishes that the received mobile phone radio signal 5 indicates the initialization of a call, it generates an output signal 7a, which is routed to the remote controller 3c (see FIG. 2) and causes the remote controller 3c to transmit a volume-influencing signal 6 to the playback device 2. In the present case, however, the volume-influencing signal 6 is also made up of a muting signal. As already mentioned, the said volume-influencing signal 6 may also be made up of a volume-reducing signal, a fading signal or a pause or stop signal to interrupt the playback of audio signals from an audio-signal source.

As shown in the block diagram of FIG. 3, the detector 7 comprises an antenna 7b and a radio-signal receiver circuit 7c to receive radio signals from a mobile phone 4, a filter 7d to filter out interference signals or short pulses from the mobile phone 4, with which the mobile phone 4 regularly reports to a base station—not shown—and a control circuit 7e, which evaluates the received radio signals and generates the control signal 7a to activate the remote controller 3c. The detector 7 is designed in such a way that it recognizes the identifier transmitted to a base station by the mobile phone 4 in reaction to incoming calls, and subsequently initiates the transmission of a volume-influencing signal 6. In an embodiment variant, the detector 7 can distinguish whether the detected identifier relates to the reception of data messages or the reception of spoken messages, and the detector 7 initiates the emission of the volume-influencing signal 6 only in the case of spoken messages.

With reference to FIG. 2, in a further embodiment of the remote control device 3 in accordance with the invention, a housing 3e of the remote control device is equipped with a mounting 3f in the form of a recess for a mobile phone 4. In addition, a charging device 3g for the mobile phone is integral to the remote control device 3, with a charging current that is available at a connector 3h on the mounting 3f. The charging device 3g is equipped with a mains-voltage connection, which is not shown.

In order to prevent radio signals from third-party mobile phones from being detected, the detection range of the detector 7 should be restricted, e.g. to 1.5 to 3 m.

In a further embodiment of the audio-signal playback system 1 in accordance with the invention, a further, universally applicable acoustic-signal detector may be provided, which detects the acoustic signal from doorbells, intercom systems etc. An acoustic detector of this kind must be disposed outside the remote control device 3, preferably in a different room, so it is not subject to interference from the high volume of the playback device 2. In the case of detection of an acoustic signal with a particular characteristic or volume, the acoustic detector emits a radio signal that can be detected by the detector 7. Following detection of this radio signal, the remote controller 3c is induced to emit a volume-influencing signal 6. In accordance with this, the acoustic-signal detector assumes the role of the mobile phone 4, and the radio signal assumes the role of the mobile-phone radio signal, wherein an identifier may also be provided in the present case. The acoustic detector should preferably be set up in the immediate vicinity of the doorbell and only react to high volume levels. This acoustic detector comprises a microphone, a microphone amplifier, a high-pass filter to filter out low-pitched sounds, impacts and structure-borne sound, which is propagated in walls, a timer (e.g. an RC element) in order that it is not sensitive to loud but very brief noises—which will never emanate from a doorbell—and a threshold trigger and transmission means for remote control purposes, plus a power supply. Optionally, a variable frequency band filter may be used in place of the high-pass filter, so that, for instance, three frequency bands are selectable in order to optimize the sensitivity of the microphone to the audio-frequency spectrum of the doorbell.

It should be mentioned that the detector 7 may also be designed to be modifiable in relation to its reception sensitivity. This gives rise to the advantage that a defined reception range for reception of the mobile-phone radio signal can be set and then adjusted in line with the particular circumstances.

1. A remote control device (3) for remotely controlling a playback device (2), which playback device (2) is designed for the acoustic playback of audio signals, and which playback device (2) is designed to receive, in a wireless manner, volume-influencing signals (6) emitted by the remote control device (3), and to control the volume of the playback of the audio signals in accordance with the received volume-influencing signals (6), wherein the remote control device (3) comprises a detector (7) for detecting mobile-phone radio signals (5) that can be generated with a mobile phone (4), and wherein, on detecting the mobile-phone radio signals (5), the remote control device (3) is designed to emit to the playback device (2), in a wireless manner, a volume-influencing signal (6) with which the volume of the playback of the audio signals by the playback device (2) can be influenced.

2. A remote control device (3) as claimed in claim 1, wherein the detector (7) is designed to detect the identifier that is transmitted to the base station by the mobile phone (4) in reaction to incoming calls and is contained in the mobile-phone radio signals (5).

3. A remote control device (3) as claimed in claim 2, wherein the detector (7) is designed to distinguish between an identifier relating to the reception of data messages and an identifier relating to the reception of spoken messages.

4. A remote control device (3) as claimed in claim 1, wherein the detector (7) is designed to ignore short signal pulses from the mobile phone (4), with which it regularly reports to the base station.

5. A remote control device (3) as claimed in claim 1, wherein the volume-influencing signal (6) represents a muting signal, a volume-reducing signal, a fading signal or a pause or stop signal to interrupt the playback of a data carrier in the playback device (2).

6. A remote control device (3) as claimed in claim 1, wherein the remote control device (3) is designed as a mounting for one or more mobile phones.

7. A remote control device (3) as claimed in claim 1, wherein the remote control device (3) comprises a charging device (3g) for a mobile phone.

8. A remote control device (3) as claimed in claim 1, wherein the range of the detector (7) for reception of the mobile-phone radio signals (5) from a mobile phone (4) is restricted to less than 3 m, preferably less than 1.5 m.

9. A remote control device (3) as claimed in claim 1, wherein the remote control device (3) is designed as an infrared or ultrasonic remote control device.

10. An audio-signal playback system (1) with a remote control device (3) as claimed in claim 1, and with a playback device (2), which playback device (2) is designed for the acoustic playback of audio signals, and which playback device (2) is designed to receive, in a wireless manner, volume-influencing signals (6) emitted by the remote control device (3), and to control the volume of the playback of the audio signals in accordance with the received volume-influencing signals (6).

11. An audio-signal playback system (1) as claimed in claim 10, wherein the playback device (2) is designed as a television set or stereo system.

12. A method of influencing the volume of the playback of audio signals, which audio signals are emitted from a playback device (2), comprising the detection of mobile-phone radio signals (5) that can be generated with a mobile phone (4) in a remote control device (3), and comprising the wireless transmission of a volume-influencing signal (6) from the remote control device (3) to the playback device (2), with which volume-influencing signal the volume of the playback of the audio signals by the playback device (2) is influenced.

13. A method as claimed in claim 12, wherein an identifier contained in the mobile-phone radio signals (5) from the mobile phone (4), which is transmitted from the mobile phone to the base station in reaction to incoming calls, is detected.

14. A method as claimed in claim 13, wherein, during detection, a distinction is made between an identifier relating to the reception of data messages and an identifier relating to the reception of spoken messages.

15. A method as claimed in claim 12, wherein, during detection of the radio signals (5) from the mobile phone (4), short signal pulses from the mobile phone (4), with which the mobile phone (4) regularly reports to the base station, are ignored.

16. A method as claimed in claim 12, wherein the volume-influencing signal (6) is made up of a muting signal, a volume-reducing signal, a fading signal or a pause or stop signal to interrupt the playback of a data carrier in the playback device (2).

17. A method as claimed in claim 12, wherein the volume-influencing signal (6) transmitted via the remote control device lies in the infrared or ultrasonic frequency range.
